(19) United States
(12) Patent Application Publication
(10) Pub. No.: US 2009/0287904 A1
(43) Pub. Date: Nov. 19, 2009

(54) SYSTEM AND METHOD TO ENFORCE ALLOWABLE HARDWARE CONFIGURATIONS

(75) Inventors: ANTHONY J. BYBELL, Atlanta, GA (US); Jason M. Sullivan, Raleigh, NC (US)

Correspondence Address: KING & SPALDING, 1180 PEACHTREE ST., ATLANTA, GA, 30309, US

(73) Assignee: International Business Machines Corporation, Armonk, NY (US)

(21) Appl. No.: 12/121,419

(22) Filed: May 15, 2008

(51) Int. Cl. G06F 12/08

(52) U.S. Cl. 711/216; 711/E12.018

(57) ABSTRACT

The present invention comprise methods and systems for enforcing allowable hardware configurations. The present invention utilizes shadow registers, which act as gatekeepers for actual sensitive configuration registers. An attempted write to the actual sensitive configuration registers is first stored in a corresponding shadow register and is subsequently validated via a cryptographic hash register before the values are passed to the actual configuration register.

### FIELD OF THE INVENTION

This invention relates to a system and method of enforcing allowable hardware configurations by only allowing sensitive configuration registers to be modified after a secure/cryptographic hash register validates that the configuration is in fact allowable.

### DESCRIPTION OF BACKGROUND

For a number of hardware devices, it is desirable to limit programmers to a restricted set of approved configurations for a given piece of hardware. An example of this would be modification of the maximum transmit signal strength value for a wireless network card. Current solutions rely on security through obscurity where the manufacturer of the hardware device provides an object file or firmware that the user must link their device drivers against. In such an environment, it is quite possible that a user could reverse-engineer the object file or firmware and be able to place the hardware device in a non-approved configuration. In addition, for open source operating systems such as Linux, the insertion of such closed source object files into the kernel is considered to taint the kernel to the point of voiding support contracts. The prior art process of updating a sensitive configuration register is described in FIG. 1. In Step 101 the user writes to a mask register to indicate which hardware devices they wish to update. In Step 102 the user writes new configuration values to the configuration register and the configuration register is updated in step 103.

### SUMMARY OF THE INVENTION

The present invention utilizes shadow registers that act as gatekeepers for actual configuration sensitive registers. When an attempted write is made to an actual sensitive configuration register, a shadow register accepts the input, but does not pass the value on to the actual configuration register until it is verified as legitimate. The sensitive configuration register can only be modified when a secure/cryptographic hash register validates that the configuration value stored in the corresponding shadow register is in fact allowable.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, it is now possible to enforce allowable hardware configurations by limiting an end users ability to directly access sensitive configuration registers.

### BRIEF DESCRIPTION OF THE DRAWINGS

The subject matter which is regarded as the invention is particularly pointed out and distinctly claimed in the claim at the conclusion of the specification. The foregoing and other objects, features, and advantages of the invention are apparent from the following detailed description taken in conjunction with the accompanying drawings in which:

FIG. 1 is a flowchart illustrating prior art operations involved in updating a configuration register.

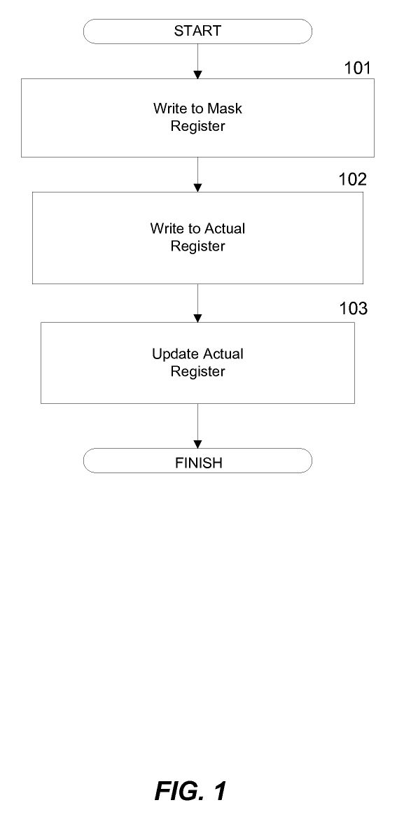

FIG. 2. illustrates an information handling system which is a simplified example of a computer system capable of implementing the embodiments of the present invention.

FIG. 3 is a flowchart illustrating operations of the present invention for enforcing allowable hardware configurations using shadow registers and validation via a secure/cryptographic hash register.

The detailed description explains the preferred embodiments of the invention, together with advantages and features, by way of example with reference to the drawings.

### DETAILED DESCRIPTION OF THE INVENTION

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

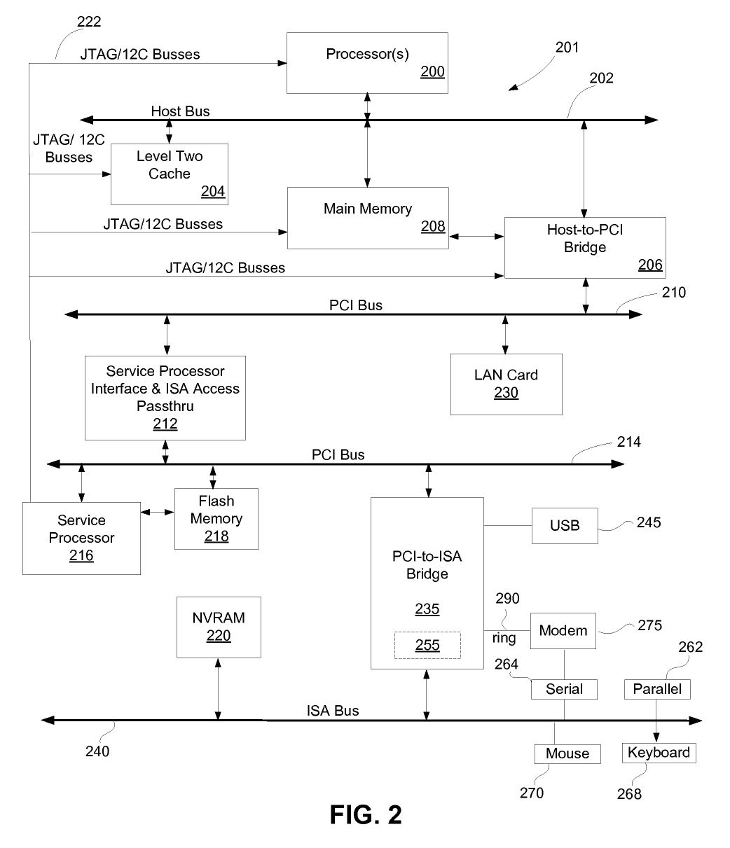

FIG. 2 illustrates an information handling system 201 which is a simplified example of a computer readable system capable of performing operations described herein. Computer system 201 includes processor 200 which is coupled to host bus 202. A level two (L2) cache memory 204 is also coupled to host bus 202. Host-to-PCI bridge 206 is coupled to main memory 208, includes cache memory and main memory control functions, and provides bus control to handle transfers among PCI bus 214, processor 200, L2 cache 204, main memory 208, and host bus 202. Main memory 208, is coupled to Host-to-PCI bridge 206 as well as host bus 202. Devices used solely by host processor(s) 200, such as LAN card 230, are coupled to PCI bus 210. Service Processor Interface and ISA Access Pass-through 212 provides an interface between PCI bus 210 and PCI bus 214. In this manner, PCI bus 214 is insulated from PCI bus 210. Devices, such as flash memory 218, are coupled to PCI bus 214. In one implementation, flash memory 218 includes BIOS code that incorporates the necessary processor executable code for a variety of low-level system functions and system boot functions.

PCI bus 214 provides an interface for a variety of devices that are shared by host processor(s) 200 and Service Processor 216 including, for example, flash memory 218. The configuration registers, shadow registers, and hash registers of the present invention will reside on the device connected to the to information handling system 201 by PCI bus 214. PCI-to-ISA bridge 235 provides bus control to handle transfers between PCI bus 214 and ISA bus 240, universal serial bus (USB) functionality 245, power management functionality 255, and can include other functional elements not shown, such as a real-time clock (RTC), DMA control, interrupt support, and system management bus support. Nonvolatile RAM 220 is attached to ISA Bus 240, universal serial bus (USB) functionality 245, power management functionality 255, and can include other functional elements not shown, such as a real-time clock (RTC), DMA control, interrupt support, and system management bus support. Nonvolatile RAM 220 is attached to ISA Bus 240. Service Processor 216 includes JTAG and 12C busses 222 for communication with processor(s) 200 during initialization steps. JTAG/12C busses 222 are also coupled to L2 cache 204, Host-to-PCI bridge 206, and main memory 208 providing a communications path between the processor, the Service Processor, the L2 cache, the Host-to-PCI bridge, and the main memory. Service Processor 216 also has access to system power resources for powering down information handling device 201.

Peripheral devices and input/output (I/O) devices can be attached to various interfaces (e.g., parallel interface 262, serial interface 264, keyboard interface 268, and mouse interface 270 coupled to ISA bus 240. Alternatively, many I/O devices can be accommodated by a super I/O controller (not shown) attached to ISA bus 240.

In order to attach computer system 201 to another computer system to copy files over a network, LAN card 230 is coupled to PCI bus 210. Similarly, to connect computer system 201 to an ISP to connect to the Internet using a telephone line connection, modem 275 is connected to serial port 264 and PCI-to-ISA Bridge 235.

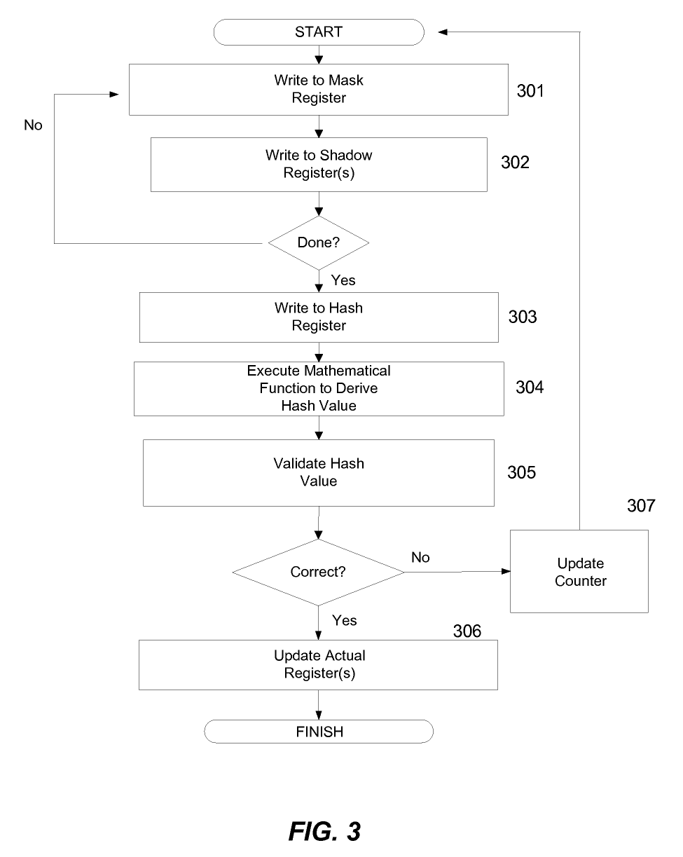

A flowchart illustrating operations and logic performed in accordance with one embodiment of the present invention is shown in FIG. 3. The process begins when a user attempts to update a sensitive configuration register. To update the configuration register, the user will first write to a mask register in step 301 to indicate which configuration registers the user would like to update. The mask can be any arbitrary size, for example an 8-bit mask and will define which configuration registers are enabled or disabled.

The user input value from the attempted write to the mask register will be copied to the hash register in step 303. After indicating which configuration registers the user intends to update by writing to the mask register, the user will then attempt to update the configuration registers by attempting to write updated configuration values to the configuration register(s).

However, the user input values from the attempted write to the configuration registers are not passed directly to the actual configuration registers, but are instead stored in step 302, in corresponding shadow registers. The shadow register acts as a gatekeeper to keep the actual configuration register from seeing the new configuration value until it is judged to be allowable. After the user has completed their attempted writes to the configuration register(s), the user input values stored in the corresponding shadow registers are also copied to the hash register.

The hash register in step 303 now contains the user input values from the attempted write to the mask register in step 301 as well as the user input values stored in the shadow register(s) in step 302. A mathematical function is then executed in step 304 using the user input values stored in the hash register to derive a hash value. The mathematical function may be a cryptographic hash function, for example a checksum hash function. Any known cryptographic hash function may be used in the context of the invention.

In step 305 the hash value is validated against predetermined allowable values. If the hash value corresponds to an accepted hash value then the write to the actual configuration values is allowed and the configuration register values are updated in step 306 to reflect the new configuration values set by the user. If the hash value does not correspond to an accepted hash value the write to the configuration register is denied and a counter is updated in step 307 to indicate that an unsuccessful write attempt occurred. Once the counter reaches a predefined count the corresponding hardware device is either permanently or temporarily disabled. In addition, it is possible to tie a valid hash to a given piece of hardware such that identification or other additional data is contained in e-fuses. In this way, allowable configurations could be tailored per-piece of hardware in situations such as when customers purchase a specific amounts of, for example, performance or bandwidth.

The above description of illustrated embodiments of the invention, including what is described in the Abstract, is not intended to be exhaustive or to limit the embodiments to the precise forms disclosed. While specific embodiments of, and examples for, the inventions described herein for illustrative purposes, various equivalent modifications are possible, as those skilled in the art will recognize. These modifications can be made to embodiments of the invention in light of the above detailed description.

What is claimed is:

1. A method for enforcing allowable hardware configurations comprising;
a) receiving a mask input value and storing the mask input value in a hash register,
b) receiving one or more configuration input values and storing in one or more corresponding shadow registers,
c) copying each configuration input value stored in the shadow registers to the hash register,
d) executing a mathematical function on the mask input and configuration input values stored in the hash register to determine a hash value,
e) if the hash value corresponds to an allowed hash value, the attempted write to the sensitive configuration registers is allowed,
f) if the hash value does not correspond to an allowed hash value, the attempted write to the sensitive configuration register is not allowed, and a counter is modified to indicate an unsuccessful write occurred, wherein once the counter reaches a predetermined count a corresponding hardware device is either temporarily or permanently disabled.
